(19) United States
(12) Patent Application Publication
(10) Pub. No.: US 2006/0103230 A1
(43) Pub. Date: May 18, 2006

(54) Washer for fitting a pitch center diameter of vehicle elements

(76) Inventor: Hung-Chuan Wu, Taipei Hsien (TW)

Correspondence Address: HUNG-CHUAN WU;Box 8-24, 235 Chung - Ho, Taipei, TW

(21) Appl. No.: 10/990,799

(22) Filed: Nov. 18, 2004

(51) Int. Cl. B60B 1/00

(52) U.S. Cl. 301/35.631

(57) ABSTRACT

A washer for fitting a pitch center diameter of vehicle elements comprises a washer body being a round short cylinder; one side of the washer body having an expansion portion and another side thereof being an inserting portion; a diameter of the inserting portion being smaller than that of the expansion portion; The washer body having an eccentric assembly hole passing through the washer body and having a central shaft shifted from an central shaft of the washer body; and a ring assembled to an outer side of the inserting portion. It is preferably that the ring is a C ring.

### FIELD OF THE INVENTION

The present invention relates to wheels, and in particular a pitch center adjustment device, wherein the washer serves for fitting a pitch center diameter of vehicle elements when the size of the vehicle wheel is changed.

### BACKGROUND OF THE INVENTION

In general, a wheel hub is installed with a brake and a wheel by screwing a screw rod of the hub into assembly holes of these elements. Thus nuts are used to lock these elements.

However, the size of a wheel for a specific car is specific. A specific wheel has a specific pitch center diameter (P. C. D.). Thereby wheel rim of different pitch center diameter can not be assembled to a same hub.

With reference to FIG. 11, it is illustrated that the pitch center diameter is defined on a wheel rim 90, which is a distance between the assembly holes 91 at two sides of a wheel rim. The pitch center diameter must fit a diameter of an assembled rod of a hub. Thus the hub fits a specific wheel rim for assembling the wheel rim to the hub.

Referring to FIG. 12, in a new design, a wheel rim 92 is formed with eight assembly holes 93, 94 so as to define different pitch center diameter.

However above design illustrated in FIG. 12 will make the cost being increased. Thereby the design in FIG. 12 is not suitable for wheel rims with defined pitch center diameter.

### SUMMARY OF THE INVENTION

Accordingly, the primary object of the present invention is to provide a pitch center adjustment device, wherein the washer serves for fitting a pitch center diameter of vehicle elements when the size of the vehicle wheel is changed.

To achieve above objects, the present invention provides a washer for fitting a pitch center diameter of vehicle elements which comprises a washer body being a round short cylinder; one side of the washer body having an expansion portion and another side thereof being an inserting portion; a diameter of the inserting portion being smaller than that of the expansion portion; The washer body having an eccentric assembly hole passing through the washer body and having a central shaft shifted from an central shaft of the washer body; and a ring assembled to an outer side of the inserting portion. It is preferably that the ring is a C ring.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is another exploded perspective view of the present invention.

FIG. 3 is a cross sectional view about the use of the present invention.

FIG. 4 is another cross sectional view about the user of the present invention.

FIG. 5 is an exploded perspective view of the use of the wheel rim of the present invention.

FIG. 6 shows one application of the present invention, wherein the present invention is used to a drum shape brake disk.

FIG. 7 shows another application of the present invention, wherein the present invention is used to a disk shape brake disk.

FIG. 8 is an exploded perspective view of the present invention, where the present invention is used to a wheel washer.

FIG. 9 is a plane view showing the use of the present invention.

FIG. 10 is a plane view showing another use of the present invention.

FIG. 11 is a structural plane view of a prior art.

FIG. 12 is a conventional structure.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

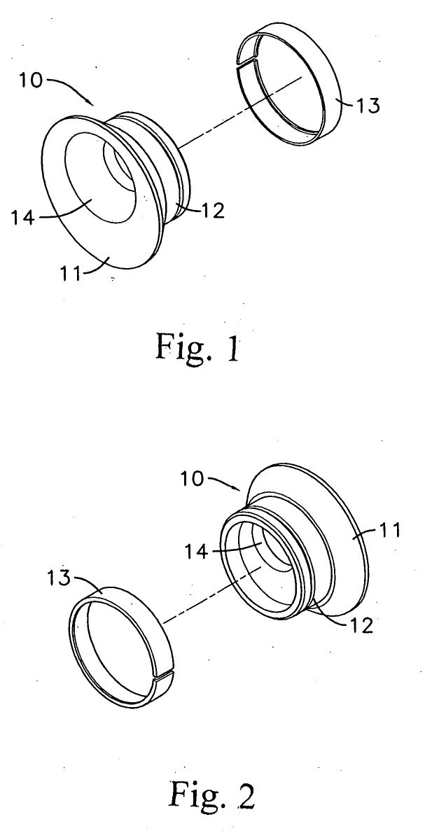

With reference to FIGS. 1 and 2, the structure of the present invention has the following elements.

A washer body 10 is a round short cylinder. One side of the washer body 10 has an expansion portion 11 and another side thereof is an inserting portion 12. A diameter of the inserting portion 12 is smaller than that of the expansion portion 11. The washer body 10 having an eccentric assembly hole 14 passing through the washer body 10 and having a central shaft shifted from an central shaft of the washer body 10.

A ring 13 is assembled to an outer side of the inserting portion 12. It is preferably that the ring 13 is a C ring.

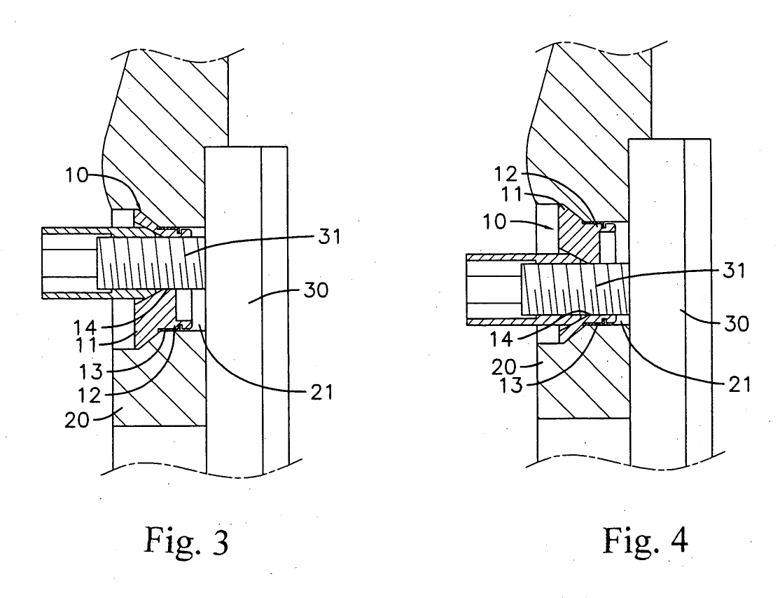

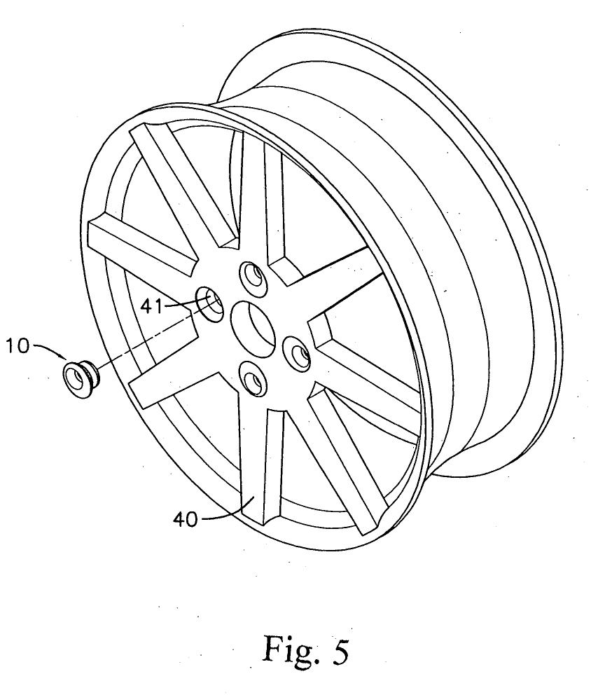

Referring to FIGS. 3 and 4, in use of the present invention, the washer body 10 is assembled into an assembly hole 21 of a wheel rim 20 so that the ring 13 contacts an inner wall of the assembly hole 21 of the wheel rim 20. When the rod 31 of a hub 30 has a larger pitch center diameter, the wheel rim 20 can be assembled to the rod 31 with a larger pitch center diameter, as shown in FIG. 3. On the contrary, when the rod 31 of a hub 30 has a smaller diameter, the eccentric assembly hole 14 of the washer body 10 is rotated to a lower position so that the washer body 10 can be assembled to the rod 31 of the hub 30 with a smaller diameter, as shown in FIG. 4.

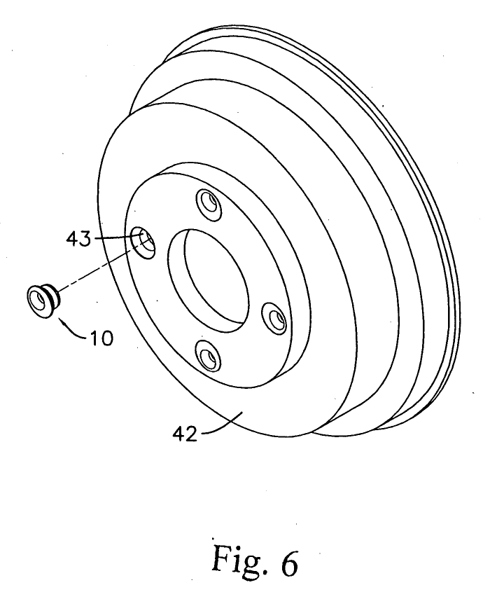

Referring to FIG. 5, by above mentioned method, the washer body 10 of the present invention can be installed to an assembly hole 41 of a wheel frame 40 for changing the pitch center diameter of the wheel frame 40.

Referring to FIG. 6, by above mentioned method, the present invention can be installed to an assembly hole 43 of a drum shape brake disk 42 for changing the pitch center diameter of the drum shape brake disk 42.

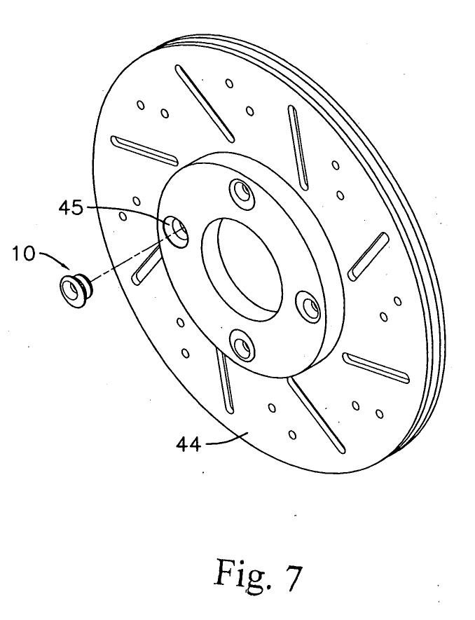

Referring to FIG. 7, by above way, the present invention can be assembled to an assembly hole 45 of a disk shape brake disk 44 for changing the diameter of the disk shape brake disk 44.

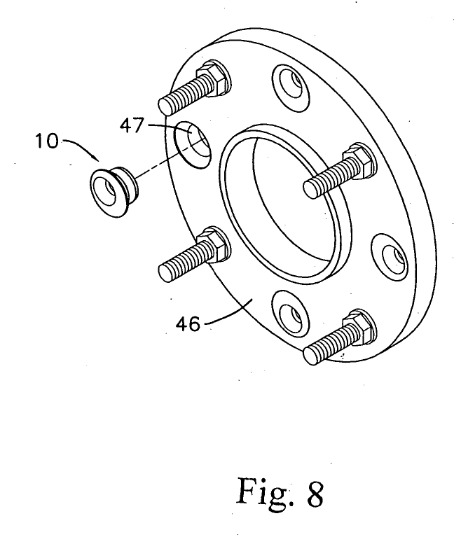

Referring to FIG. 8, it is illustrated that the present invention can be installed to the assembly hole 47 of a wheel washer 46 for changing the diameter of the wheel washer 46.

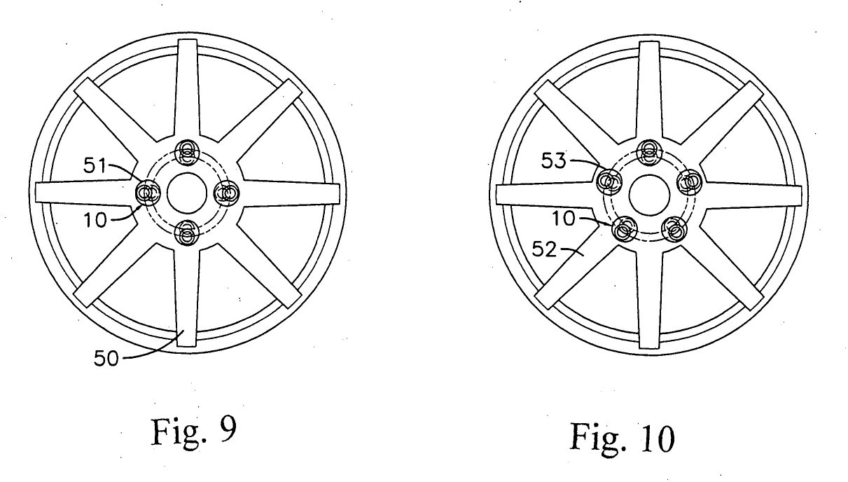

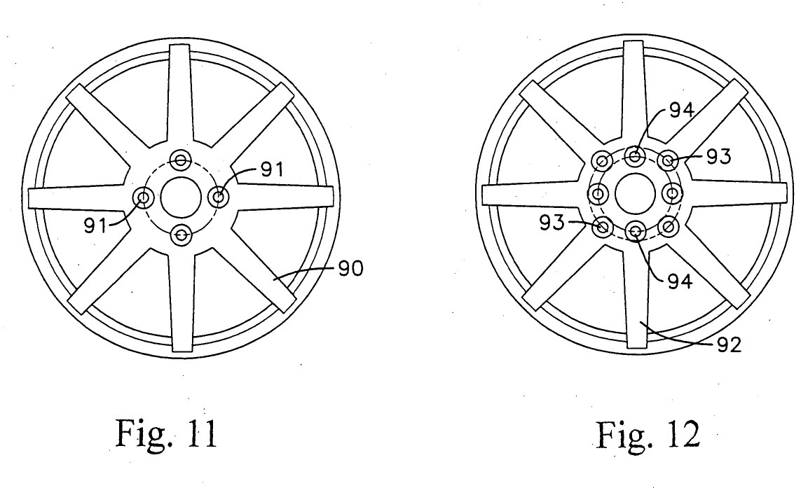

Referring to FIGS. 9 and 10, the present invention can be assembled to a wheel rim 50 with four assembly holes 51, or a wheel rim 52 with five assembly holes 53. Thereby so as to changing the diameter of the wheel rim.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A washer for fitting a pitch center diameter of vehicle elements comprising:
a washer body being a round cylinder; one side of the washer body having an expansion portion and an opposite side thereof being an inserting portion; a diameter of the inserting portion being smaller than that of the expansion portion; and the washer body having an eccentric assembly hole passing through the washer body and having a central shaft shifted from an central shaft of the washer body; and the expansion portion has a tapered shape with a small end being connected to the insertion portion; and
a ring assembled to an outer side of the inserting portion;
wherein the washer body can be placed into an assembly hole of a vehicle element so as to change a pitch center diameter of the vehicle element.

2. The washer for fitting a pitch center diameter of vehicle elements as claimed in claim 1, wherein the ring is a C ring.
